(19) United States
(12) Patent Application Publication
(10) Pub. No.: US 2011/0283312 A1
(43) Pub. Date: Nov. 17, 2011

(54) PROVIDING INFORMATION TO A VIEWER UTILIZING INTERACTIVE MEDIA

(76) Inventor: James J. Farquhar, Coronado, CA (US)

(21) Appl. No.: 12/781,696

(22) Filed: May 17, 2010

(51) Int. Cl. H04N 7/025

(52) U.S. Cl. 725/32

(57) ABSTRACT

An interactive information system includes access mechanisms for users to selectively access information. The access mechanisms may be embedded in video script content. The system may also include links for Internet access and to other information sources.

### BACKGROUND OF THE INVENTION

1. Field of the Invention

The present invention generally relates to providing information through video media. The present invention more specifically relates to systems and methods for providing information to a user through interaction with various media.

2. Background Art

Advertising is a multi-billion dollar business. An advertising campaign can determine the success or failure of a business, depending on the effectiveness of the campaign. When a product or service is advertised, the seller pays to have an advertisement created. For the advertisement to have any effect, the seller must pay again to have the advertisement posted or displayed to a target audience.

Advertisements are typically displayed by a media entity that has created an interest portal which the entity hopes will appeal to some segment of the population. Examples of interest portals include television, magazines, newspapers, movies and movie theaters, radio stations, video games, and the Internet.

A typical advertising strategy is, once a point of interest has been created for the consumers, to inundate the potential customers with ads to attempt to create brand recognition and to motivate the customers to buy the product. General advertising is likely to persuade only a miniscule percentage of exposed customers to actually make a purchase. One of the drawbacks inherent in prior art advertising is that the ads interfere with the media content selected by the viewer. Another potential negative aspect of prior art advertising is that the ads may not infrequently insult the sensibilities of the intended patron. The advertising may therefore to a large extent have a negative effect on the general viewing population.

Advertising on the Internet has attempted to address the issue of relevance. A large body of work has been developed to target advertising to the users of various websites. Advertising content is tailored to the perceived likes and dislikes of site users. Service providers may attempt to steer users to sites with potential interest to the users.

There exists a need to create a method of advertising which does not interfere with viewing content, and which is directly relevant to a large percentage of the viewing population.

In addition, interactive media makes it possible for viewers to affect the story line of events they are viewing. Viewers may have varying levels of interest in the different aspects of the event they are viewing.

To that end, an interactive viewing system that provided a mechanism for a viewer to obtain more information about topics included in a video event would be a useful advance in the art.

### SUMMARY OF THE CLAIMED INVENTION

Exemplary embodiments of the technology described herein create an interactive, precisely targeted, multi-tier, creative environment to reach a selected group of consumers that the seller desires to reach. The technology also provides a mechanism for the user to further explore items of interest that may be included in the video event. The systems and methods blend video (television, movie, big screen, Internet, gaming), print (newspaper, periodicals, books), telephone, Internet, video conferencing, computer, and collaboration software. The resulting system includes a focused and flexible method of connecting a seller and a buyer.

The system for providing information of the present invention may be initiated by providing script content for a video entertainment event. The script content may include one or more encoded information elements that may be related to the script content. As the viewer watches the video event, the encoded information elements may be displayed. The display may be triggered by the script content or by an action take by the viewer. The display of script content may be paused while the viewer examines the material contained in the information elements. The material may also be overlaid on the script content.

The system may also include one or more triggering mechanisms that direct the viewer to information sources. The sources may include access to the Internet and to various databases included in the system. Internet destinations may include blogs and product related forums as well as technical assistance centers. System databases may include price information, quality reports, and consumer satisfaction indexes. The system databases may also be resident on the Internet.

Various embodiments of the technology include a learning function. The learning function records data characteristic of at least one user of the system or method. The system or method may then associate the recorded data with one or more specific users. The learning function uses the data characteristic of and associated with a user to modify a search strategy and improve the online experience of the user.

### BRIEF DESCRIPTION OF THE DRAWINGS

FIG. 1 is a schematic diagram of an information providing system embodying the present invention.

FIG. 2 is a flowchart of various embodiments of the method of providing information disclosed herein.

FIG. 3 is a diagram of a representative computer system that may be utilized to support the systems and methods disclosed herein.

### DETAILED DESCRIPTION

Various embodiments of the systems and methods described herein provide an interactive video event. The video medium may be one of many formats, for example including television, Internet, DVD recordings, etc. Those skilled in the art will recognize that the systems and methods are not dependent on the display medium. The system allows a user to not only affect the storyline of the video event being viewed, but also to obtain further information about items of interest that are depicted in the event.

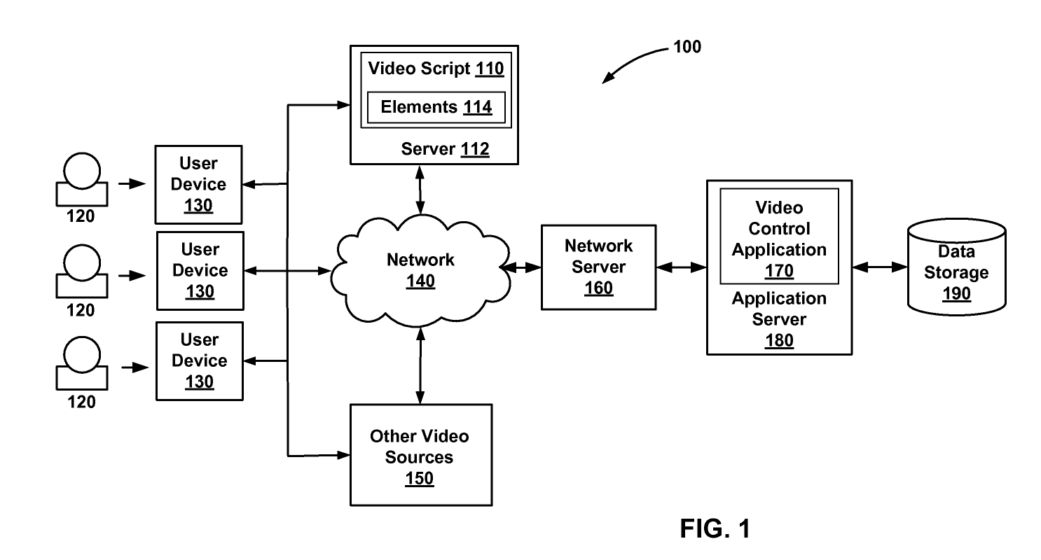

FIG. 1 illustrates a typical configuration that may be used in various embodiments of the system 100. A video script 110 is created to provide a video event for one or more users 120. A video event as used herein encompasses any form of visual display, and may or may not include audio content or other sensory input. The video script may be created at and accessed from server 112. The video script may have information and data embedded into the script, such as for example information elements 114. The video script may also be created by and/or accessed from video control application 170. Server 112 may communicate with network 140 and may be used to communicate video script 110 to video control application 170 on application server 180 or user devices 130.

The users of the system 100 may view the video event on a user device 130. The user device 130 may be a television, a computer display, a laptop or other computing device, smartphones, DVD players, etc. In short, any device 130 that has the capability to display a video event may be used as the user device 130.

The user device 130 may be in communication with the Internet or another network 140. Video events may be viewed or downloaded from the network 140 and displayed on the user device 130. Other video sources 150 may also be used to supply the video event. Other video sources 150 include but are not limited to DVDs and any other video recording or generating medium.

Servers 160 and 180 as well as data storage 190 of system 100 displayed in FIG. 1 may be used to support the various types of video input. Network 140 may be implemented as any type of communication network including but not limited to the Internet, Wide Area Network (WAN), Local Area Network (LAN), intranet, extranet, private network, or other network.

The network 140 is in communication with a network server 160. Network server 160 may be implemented as one or more machines that communicate over network 140 and communicate with application server 180. Application server 180 may communicate with network server 160 and host one or more applications or software modules which may be executed to implement the present technology.

The network server 160 may be in communication with a video control application 170. The video control application 170 may be used to control the video feed to the user device 130. The video control application 170 may be resident on and be executed by a processor on application server 180 to implement the display of the video event.

Data storage 190 may be included in the system 100. Data related to the video event may be retained in the data storage 190. Data storage 190 may be accessed by application server 180 (for example, through a query initiated by video control application 170) and may be implemented as one or more remote servers or within application server 180.

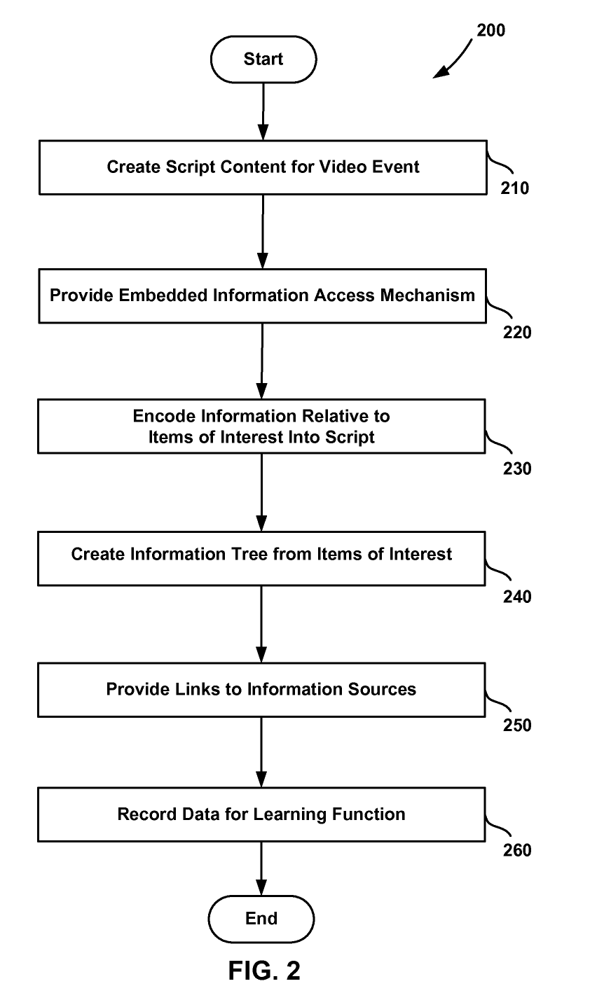

FIG. 2 illustrates a method 200 that may be used to implement the present invention. The method is initiated in a first step 210 in which script content is created for the video event. The types of content and the subject matter are limited only by the imagination and interests of the person creating the script. The script may be for entertainment purposes (a movie or TV show) or it may be informational (a documentary, a news program, educational programs, etc.). In some embodiments, the script content may merely be accessed from a local or remote location rather than created.

In another step 220, one or more access mechanisms are provided in the script content. The access mechanism may be a type of visible indicia and configured to be displayed during playback, execution, or other presentation associated with the script content provided during a video. Alternatively, the user may simply point to (as with a mouse), select, or virtually touch an item of interest being displayed in the video event. The access mechanism may then trigger the display of further available information. In some embodiments, the access mechanism may comprise script code or other code configured to provide information in response to selection of the item of interest by a user or some event, such as a predetermined point in time during video playback.

During or subsequent to the creation of the script content, information elements may be encoded into the script content in a step 230. The information elements may be encoded so that information may be provided on the display device, such that the information is visible concurrently with the main subject matter of the script, or a user may interrupt the main script content to access embedded information. The user may also be shown prompting information that alerts the user to the availability of additional information.

In another step 240, an information tree may be created. The information tree may include successive layers of information on a topic of interest. For example, the information tree for a geographic region may include a city, activities available in the region, businesses resident in the region, and products associated with any of the city, activities, or businesses.

In a step 250, links are provided to information sources. The link may be to a website, a blog, a forum, a chat room, or the like. The link may also direct the user to a non-web based source of information. For example, the link may provide the phone number or email address of a technical consultant. The link may also direct the user to a database, such as a collection of consumer reviews, pricing information, quality reports, or the like. The communication with the linked information source may be accomplished by telephone, mobile SMS (text messages), radio, digital subscriber lines (ADSL), cable, etc.

In a step 260, the system 100 may record information specific to an individual user 120 and store it in data storage 190 or another memory area. The information recorded may include characteristics of the online session of the user 120, such as sites visited, time spent on a given site, purchases made, information downloaded, etc. By tracking the user information, a learning function of the system 100 learns the habits and search patterns of each user. As information is collected by the system 100, the system 100 becomes better able to suggest relevant search patterns and information sites. The system 100 may use the recorded information to improve the efficiency of the system 100 in developing suggested sites, products, information, etc. The learning function provides the system 100 with advanced search capabilities for users with a history of use on the system 100.

Applications of the systems and methods of the present invention are essentially limitless. An illustrative embodiment might be a movie. A viewer might be interested in something the star is wearing. The user may activate an access mechanism by clicking on, selecting or virtually touching the item of interest while it is being displayed. The access mechanism may cause one or more links to be displayed in a drop down menu. The drop down menu might direct the user to an information tree that includes information about the origin of the article. The menu might also include catalog information that would allow the user to directly purchase the item.

In another example the video event might be a historical documentary. The access mechanism might cause a menu of related events to appear. The information tree might also include information about key figures in a subject historical event. Users might choose to further research the people involved and the geographical region in which the event occurred. Included links might direct the user to travel opportunities or libraries with biographical materials.

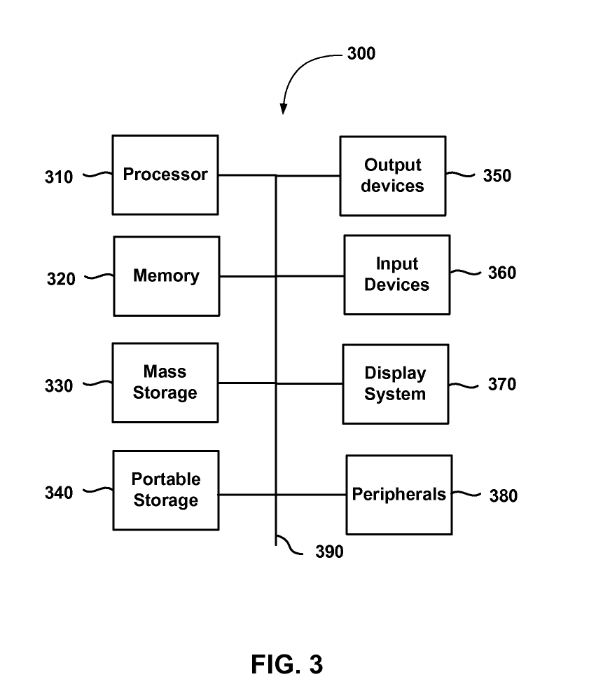

FIG. 3 illustrates an exemplary computing system 300 that may be used to implement one or more embodiments of the present technology. The computing system 300 includes one or more processors 310 and main memory 320. Main memory 320 stores, in part, instructions and data for execution by processor 310. Main memory 320 can store the executable code when in operation. The computing system 300 may further include a mass storage device 330, portable storage medium drive(s) 340, output devices 350, user input devices 360, a graphics display 370, and peripheral device(s) 380.

The components shown in FIG. 3 are depicted as being connected via a single bus 390. The components may be connected through one or more data transport means. The processor 310 and the main memory 320 may be connected via a local microprocessor bus, and the mass storage device 330, the peripheral devices 380, the portable storage medium drive(s) 340, and display system 370 may be connected via one or more input/output (I/O) buses.

The mass storage device 330, which may be implemented with a magnetic disk drive or an optical disk drive, is a non-volatile storage device for storing data and instructions for use by the processor 310. The mass storage device 330 can store the system software for implementing embodiments of the present invention for purposes of loading that software into the main memory 320.

The portable storage device 340 operates in conjunction with a portable non-volatile storage medium, such as a floppy disk, compact disk, digital video disc, or USB storage device, to input and output data and code to and from the computer system 300 of FIG. 3. The system software for implementing embodiments of the present invention may be stored on such a portable medium and input to the computer system 300 via the portable storage device 340.

The input devices 360 provide a portion of a user interface. The input devices 360 may include an alpha-numeric keypad, such as a keyboard, for inputting alpha-numeric and other information, or a pointing device, such as a mouse, a trackball, stylus, or cursor direction keys. Additionally, the computing system 300 as shown in FIG. 3 includes the output devices 350. Suitable output devices include speakers, printers, network interfaces, and monitors.

The display system 370 may include a liquid crystal display (LCD) or other suitable display device. The display system 370 processes any information it receives for output to the display device.

The peripheral device(s) 380 may include any type of computer support device to add additional functionality to the computer system. The peripheral device(s) 380 may include a modem or a router.

The components contained in the computer system 300 are those typically found in computer systems that may be suitable for use with embodiments of the present invention and are intended to represent a broad category of such computer components that are well known in the art. Thus, the computer system 300 of FIG. 3 can be a personal computer, hand held computing device, telephone, mobile computing device, workstation, server, minicomputer, mainframe computer, or any other computing device. The computer can also include different bus configurations, networked platforms, multi-processor platforms, etc. Various operating systems can be used including Unix, Linux, Windows, Macintosh OS, Palm OS, webOS, Android, iPhone OS and other suitable operating systems.

It should be noted that some of the above-described functions performed in the method 200 may be defined by instructions that are stored on storage media (e.g., computer-readable media). The instructions may be retrieved and executed by the processor of the computer on which the system is resident. Some examples of storage media are memory devices, tapes, disks, integrated circuits, and servers. The instructions are operational when executed by the processor to direct the processor to operate in accord with the invention. Those skilled in the art are familiar with instructions, processor(s), and storage media.

It should also be noted that any hardware platform suitable for performing the processing described herein is suitable for use with the invention. The terms “computer-readable media” and “storage media” as used herein refer to any medium or media that can be used to provide instructions to a CPU for execution.

Such media can take many forms, including, but not limited to, non-volatile media, volatile media, and transmission media. Non-volatile media include, for example, optical or magnetic disks, such as a fixed disk. Volatile media include dynamic memory, such as system RAM. Transmission media include coaxial cables, copper wire and fiber optics, among others, including the wires that comprise an embodiment of a bus. Transmission media can also take the form of acoustic or light waves, such as those generated during radio frequency (RF) and infrared (IR) data communications.

Common forms of computer-readable media include, for example, a floppy disk, a flexible disk, a hard disk, magnetic tape, any other magnetic medium, a CD-ROM disk, digital video disk (DVD), any other optical medium, a physical medium with patterns of marks or holes, a RAM, a PROM, an EPROM, an EEPROM, a FLASHEPROM, any other memory chip or cartridge, a carrier wave, or any other medium from which a computer can read.

The embodiments described herein are illustrative of the present invention. As these embodiments of the present invention are described with reference to illustrations, various modifications or adaptations of the methods and or specific structures described may become apparent to those skilled in the art in light of the descriptions and illustrations herein. All such modifications, adaptations, or variations that rely upon the teachings of the present invention, and through which these teachings have advanced the art, are considered to be within the spirit and scope of the present invention. Hence, these descriptions and drawings should not be considered in a limiting sense, as it is understood that the present invention is in no way limited to only the embodiments illustrated.

What is claimed is:

1. A method of providing information to a user:
creating a script content for a video entertainment event, the event being viewable on a display device;
encoding by a video control application one or more information elements into the script content; and
providing at least one access mechanism, wherein the access mechanism includes a mechanism to direct a user to information related to the script content.

2. The method of claim 1, further comprising utilizing a learning function that records data characteristic of at least one user of the method.

3. The method of claim 2, wherein utilizing the learning function includes using the data characteristic of the user to modify a search strategy for the user.

4. The method of claim 1, wherein encoding the information elements includes causing the information elements to be displayed concurrently with the script content.

5. The method of claim 1, wherein providing an access mechanism includes providing one or more trigger mechanisms embedded in the script content, wherein users access information elements by activating the trigger mechanism.

6. The method of claim 1, further comprising accessing the Internet by activating an Internet access mechanism embedded in the script content.

7. The method of claim 1, further comprising directing the user to an Internet forum related to an advertised product.

8. The method of claim 1, further comprising directing the user to a blog related to an advertised product.

9. The method of claim 1, further comprising directing the user to a price check service.

10. The method of claim 1, further comprising directing the user to a quality report service.

11. The method of claim 1, further comprising directing the user to a consumer satisfaction index.

12. The method of claim 1, further comprising directing the user to a technical representative, the technical representative being knowledgeable about a selected topic.

13. A system for supplying information to a user comprising:
a script content for a video entertainment event, the script content including one or more encoded information elements;
a display device on which a user views the script content;
a memory device to store information elements; and
a processor configured to execute a video application which implements one or more access mechanisms, the one or more access mechanisms configured to enable a user to access the encoded information elements while viewing the entertainment event, wherein at least one of the access mechanisms includes a mechanism to access information elements related to the script content.

14. The system of claim 13, further comprising a learning function that records data characteristic of at least one user of the method.

15. The system of claim 14, wherein the learning uses the data characteristic of the user to modify a search strategy for the user.

16. The system of claim 13, wherein the information elements are displayed concurrently with the script content.

17. The system of claim 13, wherein the access mechanism includes one or more trigger mechanisms embedded in the script content, the trigger mechanism causing information elements to be displayed when the trigger mechanism is activated.

18. The system of claim 13, further comprising an Internet access mechanism embedded in the script content.

19. The system of claim 13, further comprising a directing mechanism to direct the user to an Internet forum related to an advertised product.

20. The system of claim 13, further comprising a directing mechanism to direct the user to a blog related to an advertised product.

21. The system of claim 13, further comprising a directing mechanism to direct the user to a price check service.

22. The system of claim 13, further comprising a directing mechanism to direct the user to a quality report service.

23. The system of claim 13, further comprising a directing mechanism to direct the user to a consumer satisfaction index.

24. The system of claim 13, further comprising a directing mechanism to direct the user to a technical representative, the technical representative being knowledgeable about a selected topic.

25. A computer readable storage medium having embodied thereon a program, the program being executable by a processor to perform a method for providing information to a user, the method comprising:
receiving a script content for a video entertainment event, the event being viewable on a display device;
encoding by a video control application one or more information elements into the script content; and
providing at least one access mechanism, wherein the access mechanism includes a mechanism to direct a user to information related to the script content.
